(19) United States
(12) Patent Application Publication
(10) Pub. No.: US 2014/0297574 A1
(43) Pub. Date: Oct. 2, 2014

(54) PROBABILISTIC LANGUAGE MODEL IN CONTEXTUAL NETWORK

(71) Applicants: Robert Heidasch, Speyer (DE); Stefan Scheidl, Dieburg (DE); Michael Neumann, Speyer (DE); Matthias Kaiser, Walldorf (DE); Christian Lahmer, Heidelberg-Rohrback (DE); Stephan Brand, Wiesloch (GH); Nico Licht, Heidelberg (GL); Klaus Reichenberger, Frankfurt (DE); Archim Heimann, Wiesloch (DE); Steffen Moldaner, Riedstadt (DE); Thomas Pohl, Leimen-St. Ilgen (DE)

(72) Inventors: Robert Heidasch, Speyer (DE); Stefan Scheidl, Dieburg (DE); Michael Neumann, Speyer (DE); Matthias Kaiser, Walldorf (DE); Christian Lahmer, Heidelberg-Rohrback (DE); Stephan Brand, Wiesloch (GH); Nico Licht, Heidelberg (GL); Klaus Reichenberger, Frankfurt (DE); Archim Heimann, Wiesloch (DE); Steffen Moldaner, Riedstadt (DE); Thomas Pohl, Leimen-St. Ilgen (DE)

(21) Appl. No.: 14/303,435

(22) Filed: Jun. 12, 2014

Related U.S. Application Data
(63) Continuation of application No. 13/489,190, filed on Jun. 5, 2012, now abandoned.

(51) Int. Cl. G06N 3/08; G06F 17/30

(52) U.S. Cl. CPC G06N 3/08; G06F 17/30424
USPC 706/25

(57) ABSTRACT

A method and apparatus for detection of relationships between objects in a meta-model semantic network is described. Semantic objects and semantic relations of a meta-model of business objects are generated from a meta-model semantic network. The semantic relations are based on connections between the semantic objects. A probability model of terminology usage in the semantic objects and the semantic relations is generated. A neural network is formed based on usage of the semantic objects, the semantic relations, and the probability model. The neural network is integrated with the semantic objects, the semantic relations, and the probability model to generate a contextual network. The generated probability model is integrated with semantic objects and neural networks for form parallel networks.

### CROSS-REFERENCE TO RELATED APPLICATIONS

This application is a continuation of prior application Ser. No. 13/489,190, filed on Jun. 5, 2012, which is incorporated by reference herein in its entirety.

### FIELD

The present disclosure relates generally to data searches. In an example embodiment, the disclosure relates to searching enterprise data.

### BACKGROUND

Generally, a search engine is a program that is designed to search for information from a variety of sources of data, such as the World Wide Web and File Transfer Protocol (FTP) servers. Many of these conventional search engines are designed to conduct searches based on a matching of keywords. For example, a conventional search engine searches documents for keywords, which are specified by a user, and returns a list of documents in which the keywords are found.

However, conventional search engines often do not take into account the semantic meaning of the keywords found in the enterprise data, such as, for example, business objects and business documents. To clarify this discussion, a “business object,” as used herein, may refer to a representation of a business entity, such as an employee or a sales order, in an enterprise system. That is, a business object is a type of entity inside the business layer in an n-layered architecture of object-oriented computer programs. A business object encompasses both the functions (in the form of methods) and the data (in the form of attributes) of this business entity.

When searching business objects, for example, a typical search engine may simply search the attributes associated with business objects. For example, in response to receiving a query for “employees located in San Diego,” the typical search engine may return a business object of a company with a name of “San Diego Surf Shop” because the business object of the company has an attribute containing “San Diego.” However, this may not be what the user wanted because the business record is not an employee and the company is not even located in San Diego. As a result, many of these conventional search engines are notoriously inaccurate at searching for enterprise data containing keywords with meanings that depend on the context of the attribute.

### BRIEF DESCRIPTION OF DRAWINGS

The present disclosure is illustrated by way of example and not limitation in the figures of the accompanying drawings, in which like references indicate similar elements and in which:

FIG. 1 is a block diagram depicting an architectural overview of a learnable contextual network for objects in a meta-model semantic network, in accordance with an example embodiment;

FIG. 2 is a block diagram illustrating a business application, in accordance with an example embodiment;

FIG. 3 is a block diagram illustrating a contextual network, in accordance with an example embodiment;

FIG. 4 is a block diagram illustrating semantic objects/relations, in accordance with an example embodiment;

FIG. 5 is a block diagram illustrating a contextual network having a probabilistic model in communication with a text analyzer, in accordance with an example embodiment;

FIG. 6 depicts a flow diagram of a general overview of a method for learning relationships between objects in a meta-model semantic network, in accordance with an example embodiment;

FIG. 7 depicts a flow diagram of a general overview of a method for learning relationships between objects in a meta-model semantic network using a probabilistic model, in accordance with another example embodiment;

FIG. 8 depicts a flow diagram of a general overview of a method for using a probabilistic model for term usage in objects of a meta-model semantic network, in accordance with an example embodiment; and

FIG. 9 is a block diagram depicting a machine in the example form of a computing device within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures and techniques have not been shown in detail.

Some embodiments described herein provide a method and an apparatus for detection of relationships between objects in a meta-model semantic network. Semantic objects and semantic relations of a meta-model of business objects are generated from a meta-model semantic network. The semantic relations are based on connections between the semantic objects. A probability model of terminology usage in the semantic objects and the semantic relations is generated. A neural network is formed based on usage of the semantic objects, the semantic relations, and the probability model. The neural network is integrated with the semantic objects, the semantic relations, and the probability model to generate a contextual network.

Prior to discussing specific example embodiments, further descriptions of some terms are now provided for a better understanding of the descriptions set forth herein.

“Enterprise data,” as used herein, may refer to data maintained by an enterprise, such as a business, individual, group, or any other organization. Examples of enterprise data include, for example, business objects, business documents, notes, bookmarks, annotations, terminology, or any other business concept. In some embodiments, the enterprise data may be extracted from heterogeneous sources (e.g., an email database server and a purchase order database). Further, the enterprise data may be structured (e.g., type defined via a schema, such as Extensible Markup Language (XML)) or unstructured (e.g., word documents).

As used herein, a “semantic network” may refer to a network of semantic objects connected through semantic relations. A “semantic object,” as used herein, may refer to a conceptual representation of a notion recognized by an enterprise, such as a product, person, employee, customer, business, document, case, project, business object, term, or any other suitable data. A “semantic relation,” as used herein, may refer to a relationship between two or more semantic objects. Such relationships may have attributes and a type or definition that provides a conceptual meaning to how the two or more semantic objects are related to each other.

As used herein, a “meta-model semantic network” may refer to a semantic network generated based on a meta-model of the enterprise data. A “meta-model,” as used herein, is a model that characterizes the conceptual meaning of elements of a business object definition. In turn, a “model” is a characterization of instances of enterprise data. A definition of a business object is an example of a model. The definition may model an instance by defining the attributes (e.g., an address) associated with the business object. The meta-model then models these attributes and gives meaning to attributes (e.g., an address is a location).

“Semantic information,” as used herein, may refer to information that provides conceptual meaning to enterprise data. Such semantic information may associate particular enterprise data with concepts maintained by an enterprise. For example, a collection of attributes (e.g., street, city, state, zip code, and the like) may be given a meaning of understanding (e.g., location). Such semantic information may be formally organized as “semantic object definitions” and “semantic relation definitions.”

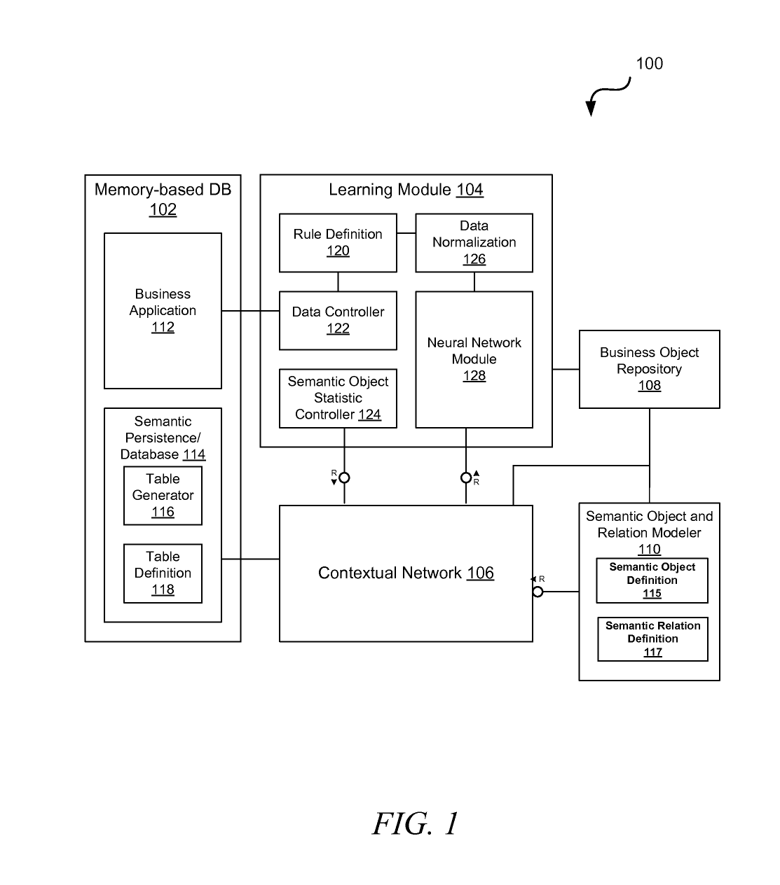

FIG. 1 is a block diagram depicting an architectural overview of a learnable contextual network system 100 for objects in a meta-model semantic network, in accordance with an example embodiment.

The learnable contextual network system 100 includes memory-based database 102, a learning module 104, a contextual network 106, a business object repository 108, and a semantic object and relation modeler 110. The learning module 104, the contextual network 106, and the semantic object and relation modeler 110 may be embodied, individually or in combination, in a computing device in the form of, for example, a personal computer, a server computer, or any other suitable computing device. In various embodiments, the computing device may be used to implement computer programs, logic, applications, methods, processes, or software to determine existing relationships between objects in a meta-model semantic network using information as described in more detail below.

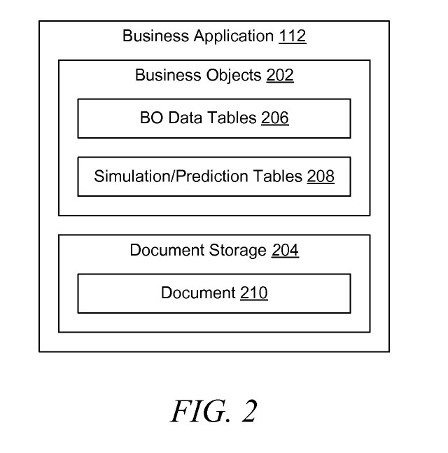

In one embodiment, the memory-based database 102 includes a business application 112 and a semantic persistence/database 114. The memory-based database 102 includes, for example, SAP HANA DB from SAP, a German company. The memory-based database 102 may be used by business application 112, which contains business objects. FIG. 2 illustrates one embodiment of a business application 112 that includes business objects 202 and document storage 204. The business objects 202 may include business object data table 206 (e.g., business data) and simulation/prediction tables 208. The document storage 204 includes business documents 210.

Referring back to FIG. 1, the semantic persistence/database 114 is configured to store a table generator 116 and a table definition 118. For example, the table generator 116 may be configured to generate tables used as storage for information (data and metadata) used by a contextual network 106 (e.g., persistence for semantic objects and relation), and a neural network. For example, the table definition 118 may include data and metadata used by a contextual network 106 (see above) and the tables may contain instance data of particular semantic objects and relations, and existing neural network (e.g. neural network configuration data (e.g. configuration data describing input and output perceptrons)), training data—data used to train particular neural network (e.g. training, validation and test data), and data generated during usage of the neural network by the end-user (e.g. calculated prediction data).

The contextual network 106 communicates with the memory-based database 102, the learning module 104, the business object repository 108, and the semantic object and relation modeler 110.

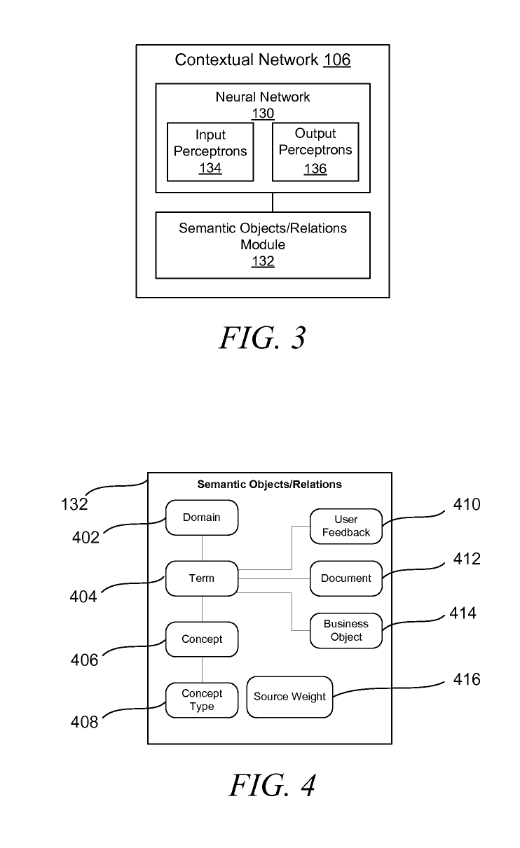

FIG. 3 illustrates an example embodiment of the contextual network 106. The contextual network 106 integrates a neural network 130 with a semantic objects/relations module 132. The contextual network 106 may be seen as an extension of a meta-model semantic network that contains the semantic objects and semantic relations from semantic objects/relations module 132 and the neural network 130.

FIG. 4 illustrates an example of a semantic objects/relations module 132. The semantic objects/relations module 132 includes nodes that link a term 404 to a domain 402 and a concept 406. In turn, the concept 406 may be linked to a concept type 408. Although FIG. 4 shows the nodes of a semantic network of contextual network 106 as single entities, it is to be appreciated that the semantic network may include fewer or more nodes apart from those shown in FIG. 4. For example, a concept 406 may be linked to one or more terms 404. Still further, additional and different nodes may be utilized by a meta-model semantic network.

The term 404 may be a word or phrase found in a business application, a document, the Internet or Web, or manually created by an end-user. The concept 406 may refer to a unit of meaning to which the term 404 refers, such as a specific idea or notion. The concept 406 groups all the terms that are used to express this idea as synonyms. For example, a product may be associated with multiple product names. Accordingly, each of the product names may be stored as separate terms 404 in the meta-model semantic network, but all be linked to the same product concept 406.

The domain 402 may associate the term 404 with a particular knowledge domain used within an enterprise. A collection of terms 404 associated with a particular domain 402 may then define the vocabulary used to describe concepts 406 in a knowledge domain 402.

The concept type 408 may be metadata that characterizes the attributes associated with the concept 406. The concept type 408 may, for example, describe the attributes associated with the concept 406 for a particular product.

The contextual network 106 may also include nodes that relate the term 404 to enterprise data, such as a user feedback object 410, a document 412, and a business object 414 and/or its elements. A user feedback object 410 may be any data embedded into enterprise data to provide further contextual data to the enterprise data. Notes, bookmarks, annotations, or any other user embedded data are examples of user feedback objects 410.

In some embodiments, the semantic relations between the term 404 and the nodes 410, 412, 414 may be influenced by a source weight 416. The source weight 416 may be a weighting factor that makes some relationships more relevant. In some embodiments, the source weight 416 may indicate that a node is more or less relevant based on the user feedback object 410. In other cases, a document 412 that merely mentions some of the attributes of a concept 406 may receive a lesser weight than a business object that includes many of the relevant relations and attributes.

Referring back to FIG. 1, the semantic persistence database 114 may store different meta-model semantic networks of contextual network 106. For example, a first meta-model semantic network may include semantic relations and semantic objects optimized to respond to queries directed to sales orders (e.g., who created a sales order, which suppliers provide a certain part, etc), while another meta-model semantic network may include semantic relations and semantic objects optimized to respond to queries related to finding experts in a domain.

As described above, the contextual network 106 may contain or include a neural network 130 in addition to a semantic network that includes semantic objects/relations module 132, which provides meaning to particular enterprise data, such as, for example, business objects, business documents, notes, bookmarks, annotations, terminology, or any other business concept or enterprise data used within the enterprise. For example, John Smith, as a concept within the enterprise, may be associated with various business objects (e.g., a sales order, employee record, customer record, or any other suitable business object) and with documents created or otherwise involving John Smith.

As described above, the semantic objects/relations module 132 stored in the contextual network 106 may be based, in part, on semantic object definitions 115 and semantic relation definitions 117 of the semantic object and relation modeler 110. Such semantic definitions may be based on a meta-model of the enterprise data. For example, the semantic object and relation modeler 110 is a modeling tool that uses a meta-modeling based approach to generate a semantic object definition 115 and a semantic relation definition 117. The semantic object definition 115 and the semantic relation definition 117 may extend the definitions of enterprise data (e.g., business objects) at the meta-model level to provide semantic information. Such semantic information provides supplemental meaning to the elements, attributes, and relations between the business objects. As an example, the definition of an employee business object may be associated with an address. In some embodiments, such an address may be a field of the business object, and, in other embodiments, such an address may be represented by a separate business object. In this example, the semantic object and relation modeler 110 may extend the definition of the employee definition, at the meta-model level, to give the address field the semantic meaning of location. That is, the association between the employee and the address characterizes the location of the particular employee.

In some embodiments, to assist an enterprise user in creating the semantic object definition 115 and the semantic relation definition 117, the semantic object and relation modeler 110 may extract existing enterprise definitions stored in a business object repository 108. For example, a source of business object definitions in an SAP environment may be the SAP Enterprise Service Repository (ESR) or the SAP By-Design Model Repository. Once the business object definitions are extracted from the business object repository 108, the semantic object and relation modeler 110 may be configured to provide, for example, a user interface to an enterprise user so that the enterprise user can model such definitions in a way that gives semantic meaning to the business objects.

The semantic object and relation modeler 110 may be configured to send the semantic object definition 115 and the semantic relation definition 117 to the contextual network 106 (for example, in particular to the semantic objects/relations module 132). In turn, the semantic objects/relations module 132 may generate rule definitions.

As described above, the contextual network 106 may store relations with enterprise data. In some embodiments, the contextual network 106 may receive the enterprise data through a text analyzer (not shown). The text analyzer is configured to extract enterprise data from enterprise data sources and export objects and relations to the contextual network 106. The text analyzer may extract enterprise data stored by enterprise systems, such as a business object stored by a business application and/or a document stored by a document storage system. The business application and the document storage system are examples of enterprise data sources. As is explained below, data derived from the business object and the document may be obtained through a crawler. Based on the rule definition, the text analyzer communicates objects and relations to the contextual network 106.

The business terminology and the business information may be integrated in the contextual network 106, also referred to as a contextual network graph.

Elements of the contextual network 106 graph include semantic objects and semantic relations 132 (relations between particular semantic objects) that allow defining semantically particular business objects, documents, domains, terms, concepts, cases, notes, bookmarks, and the like (any kind of object that encapsulates some data and/or functionality). The semantic relation is an object defined by, respectively, a meta-model that defines the link type, its importance (source weight—authority, see below), direction (simple/bidirectional), and the like. The semantic relation also defines the elements of interest for the semantic compound relations—relation chains that allows finding experts (who is working on particular topic, using particular terminology, etc) relevant documents (e.g. which documents are describing sale of particular material, etc.), business partners (e.g. which supplier offers a required material that fulfills conditions). One aspect of the present embodiment is the scalability and performance of the contextual network graph 106.

As illustrated in FIG. 3, the neural network 130 may include input perceptrons 134 and output perceptrons 136. The input and output perceptrons 134 and 136 (input and output layer elements) of the neural network 130 are integrated with the semantic object and its elements. In other words, the input and output perceptrons 134 and 136 do not feed to the neural network 130's hidden layers. In this case, the semantic relations are extended and may be additionally defined by the neural-based relations. Therefore, if a business user requests some information/relation, the contextual network 106 provides the possibility to depict its function and offers the simulation functionality.

The particular semantic objects and their elements can be used as the integration or anchor points to many input and/or output perceptrons 134 and 136. This means the contextual network 106 supports “multi-layering” of the neural network 130 which can be understood as a “parallel” defined neural network 130 that may depict different aspects of business functionality. This is accomplished with a slightly different definition of used input and output elements.

Referring back to FIG. 1, the learning module 104 allows the calculation of dependencies between particular business elements (e.g., how marketing campaigns (cost and marketing actions) influence the required investments (existing production capacity) and the short- and long-term financial benefits). The learning module 104 consists of rule definition 120, data controller 122, data normalization 126, and neural network module 128 that support integration of the learning module 104 with memory-based database 102 and the creation and calculation of neural network 130.

The rule definition 120 defines how the existing data in memory can be combined to build particular input parameters. The module may use modeling environments and the business data definitions stored in the Business Object Repository 108 to build rules.

The data normalization 126 is a module that automatically normalizes the input data and is mainly used to simplify the learning calculation of the neural network 130 (speed-up the learning process of neural network 130).

The data controller 122 is a module that controls the access to the SAP HANA DB data (a different controller may be used to access other memory based DBs) and transfers the required data in memory to and from the DB. The read action is related to data (e.g., input and output parameters) used in the learning phase and also to simulation/prediction input data in productive usage. The write operation is related to output parameters in productive usage that are then stored in separate tables. The tables may be generated by the table generator 116 on the fly and reflect the input and output parameters of the network(s).

The neural network module 128 creates and calculates a neural network 130 that represents the relations between particular business elements. The configuration of the network requires defining a few initial parameters (e.g., network type (supervised/non-supervised), network architecture (hidden layers, etc.), and used optimization method (e.g., usage of back-propagation or other methods)).

The semantic object statistic controller 124 allows the statistical analysis of the existing connections/links between particular semantic objects. The relations are created regarding business functionality defined in existing business applications and detected in different business related documents. Additionally, system interaction with the end-user (e.g., business expert) allows detection of the requested connections (e.g., the end user finds semantic objects by creating notes, favorites cause creation of new semantic relations). These relations are strengthened and become more important if they are often used in business applications, business documents, and by the end-users. In one embodiment, this information is the basis of the statistical analysis in the statistic controller 124.

The strongest and/or most important semantic relation is then provided to the business expert that can manually or automatically (the system using the business element definition and the respective business data) use a machine learning algorithm to create and optimize the neural network 130. The newly created network is then automatically integrated into contextual network 106 and exposed for usage by the business user. In this case, the system automatically creates a cycle: business application, document, or user interaction causes a creation of semantic relations; its usage causes creation of the neural network 130; and the business object and knowledge definition together with business data allows building and training of the network, which is finally integrated into the contextual network 106. The previous situation may also be referred to as self-learning functionality in business applications.

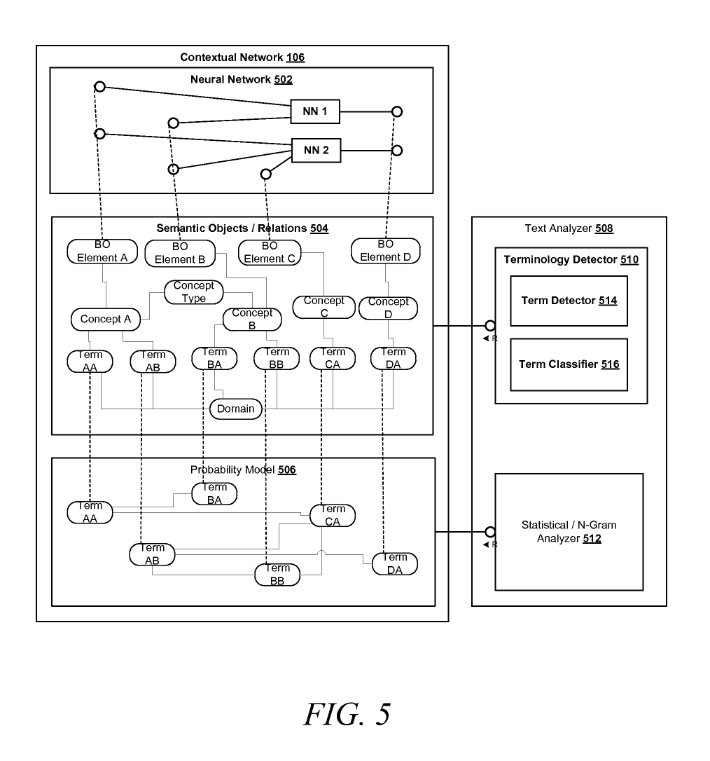

FIG. 5 illustrates another embodiment of a contextual network 106. The contextual network 106 consists of three layers: a neural network 502, a semantic objects/relations module 504, and a probability model 506. The probability model 506 contains existing business terminology that can be detected in business documents. The semantic objects/relations module 504 contains the semantic objects and semantic relations as previously described. The neural network 502 contains neural network 130 build by the learning module 104 using the existing relations between semantic objects and data integrated in the memory-based database 102, such as SAP HANA DB. The input and output perceptrons 134 & 136 (input and output layer elements) of the neural network 502 are assigned to the semantic objects in semantic objects/relations 504 (e.g., see links to respective business object elements—BO elements A, B, C and D in FIG. 5) and to the neural network 502′s hidden layers presented as “black box”—see NN 1 and NN 2 in FIG. 5.

The business terminology (terms building terminology) may represent knowledge domains that reflect the particular business areas. Furthermore, the terminology synonyms can be grouped into concepts (as semantic object) defined/described by metamodel in contextual network 106.

In one embodiment, the text documents (in different data formats) are source of business terminology (terms =words and phrases) and business information. The documents may be written in natural languages. Therefore NLP (natural language) methodology may be applied to the business definition (metamodel-based semantic object) and its business-relevant relations modeled as neural-based relations (neural network 502). FIG. 5 illustrates an example of parallel neural networks NN1 and NN2.

The terms used and their relations, which define business meaning, can be analyzed using probabilistic language models. In the communication theory, computational linguistic, sequence analysis and linguistic data compression use the n-gram model that allows prediction of the next item in a sequence and uses the form of a (n−1)-order Markov model. This model is important because it simplifies the problem of learning the language model from data. In addition, because of the open nature of language, it is common to group words unknown to the language model together.

In one embodiment, the Markov model is used as a method of approximation of the natural language. Its integration into the contextual network 106 allows the building of a business expert system that contains the terminology (terms/concepts with metadata defined as semantic objects), business objects (defined as semantic objects), business-relevant relations (modeled as neural-based relations), and the language model. The smooth integration of these models builds new possibilities for a business expert system that is provided by business applications, such as SAP Semantic Business Applications.

With respect to FIG. 5, the probability model 506 consists of existing terminology that is defined as a semantic object. The terminology is detected and found in analyzed business documents. This means, in the system initialization phase (system installed in customer environment), respective terminology crawlers may start searching for existing documents and submit them to the text analyzer 508. The text analyzer 508 uses a terminology detector 510 to determine usage in the document terminology and compare it with currently existing terminology (an SAP expert system provider may deliver the initial business terminology, e.g. SAP terms). A term classifier 516 classifies the term based on comparison (for example, complex terms using the existing terms).

In one embodiment, the generated probability model is integrated with semantic objects and neural networks for form parallel networks. As such, several networks may be processed in parallel.

The text analyzer 508 also includes a statistical/N-gram analyzer 512. The statistical/N-gram analyzer 512 may be used to determine the term relations and their statistics. The statistical/N-gram analyzer 512 analyzes the text documents using an N-gram algorithm that calculates probability of usage of particular words in the “nearest neighborhood” and integrates the terms into the probability model 506. The integration means that the term is assigned with other terms. The assignment contains N-grams of the following sizes: 1 is referred to as a “unigram” (no neighborhood relation); size 2 is a “bigram” (or, less commonly, a “digram”—one level neighborhood); size 3 is a “trigram” (two level neighborhood); size 4 is a “four-gram” (three level neighborhood) and size 5 or more is simply called an “N-gram” (four level neighborhood). It should be noted that the terms are directly linked to the respective semantic object form semantic object/relation network which describes the term meaning (metamodel, relations to business objects/elements, etc.).

The combination of the three “sub-networks” in contextual network 106 provides new possibilities: linguistic relations, semantic relations (terminology—business object/functionality) and business relations (relation between business elements presented by neural models). These layers allow building new functionality on SAP HANA solutions. For example, a user may read or write a business document and obtain business relevant suggestions about terminology from a business document, business relations or even estimate its strength (what would be the influence of the investment return when tax change, etc.). This same functionality is available in a business application, where a user working on some process needs more understanding of proper terminology or tries to analyze the document's influence on business planning (e.g. you are working on material and you need documentation of the material composition from the construction office, etc.).

The present solution can be integrated with the business platform provider (e.g. SAP) and communicate the existing relation to the central system. This allows the consolidation of the relations in the platform provider system and may be used to build subsequent versions of the contextual network 106 that are delivered to other customers (the platform provider may learn by examples from customer systems).

With respect to FIG. 1, it should be appreciated that in other embodiments, the system 100 may include fewer or more components apart from those shown in FIG. 1. For example, in an alternate embodiment, the learning module 104 can be integrated within the contextual network 106. The components and respective modules shown in FIG. 1 may be in the form of software that is processed by a processor. In another example, as explained in more detail below, the components and respective modules shown in FIG. 1 may be in the form of firmware that is processed by application specific integrated circuits (ASIC), which may be integrated into a circuit board. Alternatively, the components and respective modules shown in FIG. 1 may be in the form of one or more logic blocks included in a programmable logic device (for example, a field programmable gate array). The components and respective modules shown in FIG. 1 may be adapted, and/or additional structures may be provided, to provide alternative or additional functionalities beyond those specifically discussed in reference to FIG. 1. Examples of such alternative or additional functionalities will be discussed in reference to the flow diagrams discussed below.

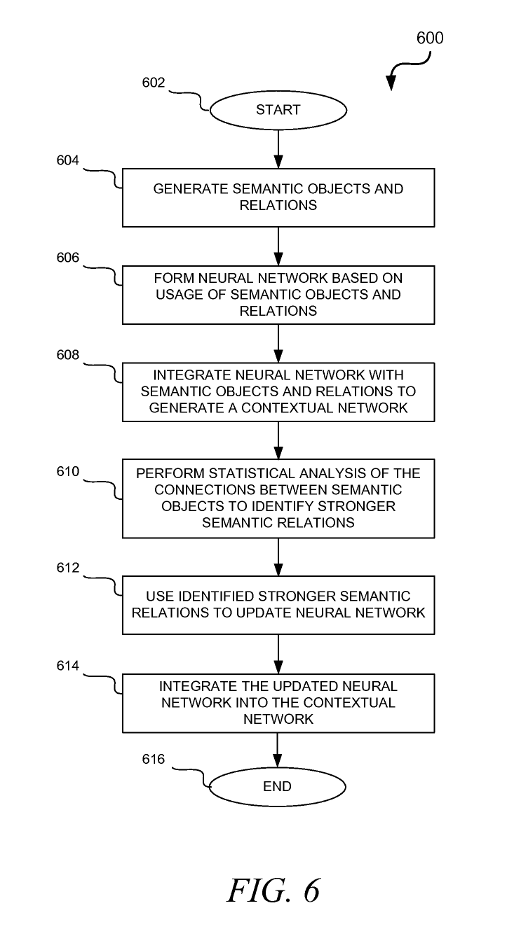

FIG. 6 depicts a flow diagram of a general overview of a method 600 for learning relationships between objects in a meta-model semantic network, in accordance with an embodiment. In an example embodiment, the method 600 may be implemented by the learning module 104 and contextual network 106 included in the system 100 of FIG. 1. The method for learning relationships between objects in a meta-model semantic network may begin at operation 602.

At operation 604, semantic objects and semantic relations of a meta-model of business objects are generated from a meta-model semantic network. The semantic relations are based on connections between the semantic objects.

At operation 606, a neural network 130 is formed based on usage of the semantic objects and the semantic relations.

At operation 608, the neural network 130 is integrated with the semantic objects and the semantic relations to generate a contextual network 106.

At operation 610, a statistical analysis of the connections between the semantic objects in the contextual network 106 is performed to identify stronger semantic relations.

At operation 612, the identified stronger semantic relations are used to update the neural network 130.

Finally, at operation 614, the updated neural network 130 is integrated into the contextual network 106. The method ends at operation 616.

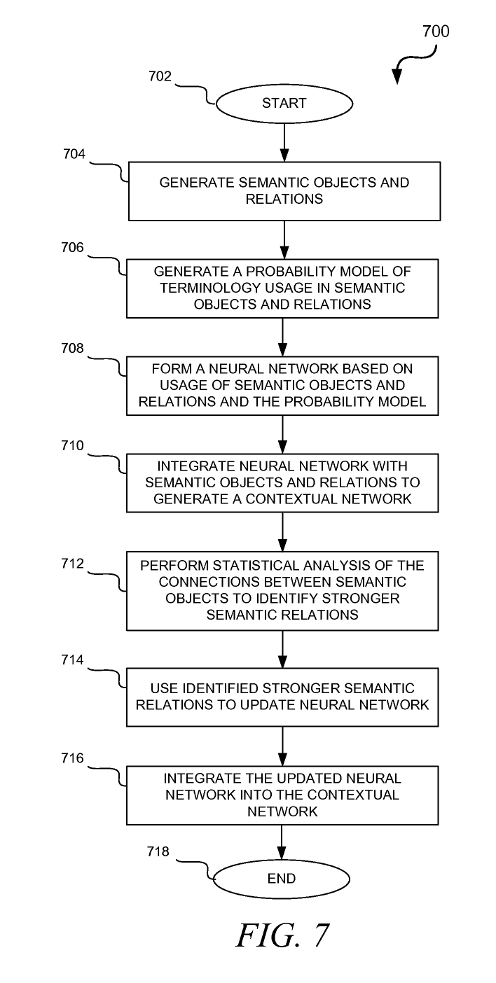

FIG. 7 depicts a flow diagram of a general overview of a method for learning relationships between objects in a meta-model semantic network using a probabilistic model, in accordance with another example embodiment. In an example embodiment, the method 700 may be implemented by the learning module 104 and contextual network 106 of FIG. 5 with the probability model 506 included in the system 100 of FIG. 1. The method for learning relationships between objects in a meta-model semantic network may begin at operation 702.

At operation 704, semantic objects and semantic relations of a meta-model of business objects are generated from a meta-model semantic network. The semantic relations are based on connections between the semantic objects.

At operation 706, a probability model 506 of terminology usage in the semantic objects and the semantic relations is generated. In one embodiment, the terminology usage is detected from the semantic objects and the semantic relations. A statistical analysis of the terminology usage is performed to generate the probability model 506 of terminology usage.

In one embodiment, the detection of the terminology usage includes detecting words and phrases in text documents from the semantic objects, comparing the detected words and phrases with an existing terminology, and classifying the detected words and phrases based on the comparison.

In one embodiment, the statistical analysis is performed by analyzing the text documents from the semantic objects using an n-gram algorithm, calculating a probability of terminology usage of words in a term neighborhood, and integrating the probability of terminology usage into the probability network.

At operation 708, a neural network 130 is formed based on usage of the semantic objects, the semantic relations, and the probability model 506.

At operation 710, the neural network 130 is integrated with the semantic objects, the semantic relations, and the probability model 506 to generate a contextual network 106.

At operation 712, a statistical analysis of the connections between the semantic objects in the contextual network 106 is performed to identify stronger semantic relations.

At operation 714, the identified stronger semantic relations are used to update the neural network 130.

Finally, at operation 716, the updated neural network 130 is integrated into the contextual network 106. The method ends at operation 718.

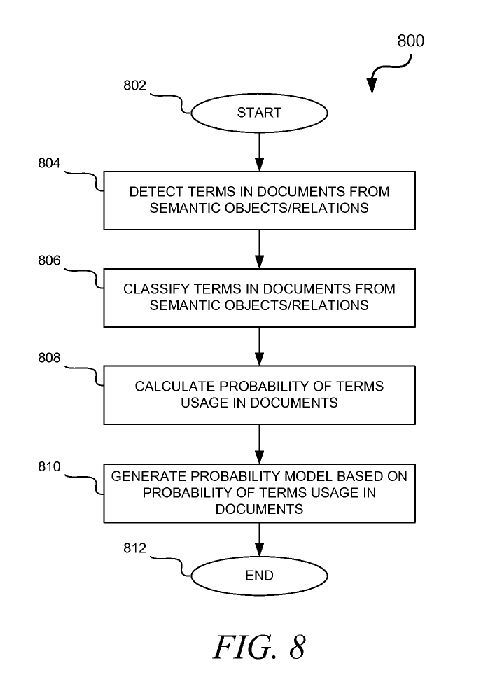

FIG. 8 depicts a flow diagram 800 of a general overview of a method for using a probabilistic model for term usage in objects of a meta-model semantic network, in accordance with an example embodiment. The method for using a probabilistic model for term usage in objects of a meta-model semantic network may begin at operation 802. At operation 804, terms are detected in business documents from semantic objects/relations. At operation 806, the detected terms are classified from semantic objects/relations. At 808, the probability of terms usage in the business documents is calculated. At 810, a probability model 506 is generated based on the calculation of the probability of terms usage in the business documents.

The present disclosure allows automatic detection of business relations that are most interesting/very often used by the business user. Additionally, because the solution is tightly integrated with the Learning Enterprise in SAP HANA DB solution, it automatically creates the simulation/prediction functionality; this means the end-user selects which relation in the calculated neural network 130 may be presented. The solution offers code-less building and machine-supported building of business relations (neural-based relations) and their calculation using learnable technologies (supervised and non-supervised neural networks 130). This helps business users to automatically detect and present factual business-relevant relations and their usage in business planning (e.g., simulation of potential business scenarios).

The direct connection to the memory-based database allows deep integration of required functionality—storing semantic objects and relations in the SAP HANA DB and its very fast statistical analysis and usage supported by SAP HANA DB direct data controllers (direct memory access to data that speeds up the functionality) and creation of rules that are used to prepare data (usage of L-language which is deeply integrated in SAP HANA DB and allows direct-in-memory pre-calculation of business data). This has tremendous benefits—the real knowledge data and business data are used in learning processes and the training of relation algorithms and training/network optimization processes may run frequently, which guarantees the constant adaptation of the algorithm to the current relation modifications. In this situation, the changing business knowledge and newest business data may result in the detection of changes in customer behavior and so forth, and the machine learning algorithms (e.g., neural networks 130) may automatically adapt to the business modification (no code modification required as in standard prediction algorithms).

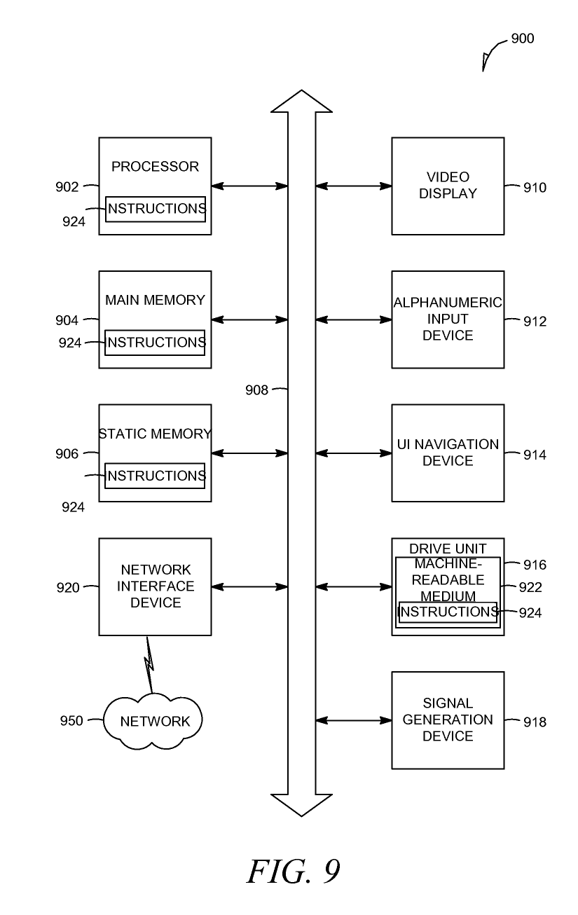

FIG. 9 depicts a block diagram of a machine in the example form of a computing device 900 within which may be executed a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the computing device 900 includes a processor 902 (e.g., a central processing unit (CPU), a graphics processing unit (GPU) or both), a main memory 904 (e.g., random-access memory), and static memory 906 (e.g., static random-access memory), which communicate with each other via bus 908. The computing device 900 may further include video display unit 910 (e.g., a plasma display, a liquid crystal display (LCD), or a cathode ray tube (CRT)). The computing device 900 also includes an alphanumeric input device 912 (e.g., a keyboard), a user interface (UI) navigation device 914 (e.g., a mouse), a disk drive unit 916, a signal generation device 918 (e.g., a speaker), and a network interface device 920.

The disk drive unit 916 (a type of non-volatile memory storage) includes a machine-readable medium 922 on which is stored one or more sets of data structures and instructions 924 (e.g., software) embodying or utilized by any one or more of the methodologies or functions described herein. The data structures and instructions 924 may also reside, completely or at least partially, within the main memory 904, static memory 906 and/or within the processor 902 during execution thereof by computing device 900, with the main memory 904, static memory 906 and processor 902 also constituting machine-readable, tangible media.

The data structures and instructions 924 may further be transmitted or received over a computer network 950 via network interface device 920 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the computing device 900) or one or more hardware modules of a computer system (e.g., a processor 902 or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an ASIC) to perform certain operations. A hardware module may also comprise programmable logic or circuitry (e.g., as encompassed within a general-purpose processor 902 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 902 configured using software, the general-purpose processor 902 may be configured as respective different hardware modules at different times. Software may accordingly configure a processor 902, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmission (e.g., over appropriate circuits and buses) that connects the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

The various operations of example methods described herein may be performed, at least partially, by one or more processors 902 that are temporarily configured (e.g., by software) or permanently configured to perform the relevant operations. Whether temporarily or permanently configured, such processors 902 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 902 or processor-implemented modules. The performance of certain of the operations may be distributed among the one or more processors 902, not only residing within a single machine, but deployed across a number of machines. In some example embodiments, the processors 902 may be located in a single location (e.g., within a home environment, an office environment or as a server farm), while in other embodiments the processors 902 may be distributed across a number of locations.

While the embodiment(s) is (are) described with reference to various implementations and exploitations, it will be understood that these embodiments are illustrative and that the scope of the embodiment(s) is not limited to them. In general, techniques for data searches using context information may be implemented with facilities consistent with any hardware system or systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

What is claimed is:

1. A method comprising:
generating semantic objects and semantic relations of a meta-model of business objects from a meta-model semantic network, the semantic relations based on connections between the semantic objects;
using a processor of a machine to generate a probability model of terminology usage in the semantic objects and the semantic relations;
forming a neural network based on usage of the semantic objects, the semantic relations, and the probability model; and
integrating the neural network with the semantic objects, the semantic relations, and the probability model to generate a contextual network.
